(19) United States
(12) Patent Application Publication
(10) Pub. No.: US 2025/0223175 A1
(43) Pub. Date: Jul. 10, 2025

(54) SYSTEMS AND METHODS FOR CONVERSION OF ORGANIC FEEDSTOCK TO CARBON ALLOTROPES USING THERMAL PLASMA

(71) Applicant: UNIVERSITY OF MARYLAND, COLLEGE PARK, College Park, MD (US)

(72) Inventors: Liangbing HU, Woodbridge, CT (US); Ji-Cheng ZHAO, Dublin, OH (US); Minhua ZHAO, Clarksburg, MD (US); Tangyuan LI, College Park, MD (US)

(21) Appl. No.: 19/016,480

(22) Filed: Jan. 10, 2025

Related U.S. Application Data
(60) Provisional application No. 63/619,670, filed on Jan. 10, 2024.

(51) Int. Cl. C01B 32/205

(52) U.S. Cl. CPC C01B 32/205; C01P 2002/01; C01P 2002/72; C01P 2002/82; C01P 2004/03; C01P 2004/04; C01P 2006/40

(57) ABSTRACT

An organic feedstock can be converted to one or more carbon allotropes by subjecting the organic feedstock to a high temperature of at least 4000 K for 60 seconds or less. The high temperature is provided by a thermal plasma generated between a pair of electrodes. In some examples, the organic feedstock includes particles of a biomass, organic polymer, and/or carbon black, and the one or more carbon allotropes are hard carbon, graphite, graphene, or carbon nanotubes.

### CROSS-REFERENCE TO RELATED APPLICATIONS

The present application claims the benefit of and priority under 35 U.S.C. § 119 (e) to and is a non-provisional of U.S. Provisional Application No. 63/619,670, filed Jan. 10, 2024, entitled “Systems and Methods for Synthesizing High-Quality Carbon Using Atmospheric Thermal Plasma,” which is hereby incorporated by reference herein in its entirety.

### FIELD

The present disclosure relates generally to synthesis of carbon allotropes, such as hard carbon, graphite, graphene, and carbon nanotubes, and more particularly, to conversion of organic feedstock to carbon allotropes via high-temperature heating using a thermal plasma.

### BACKGROUND

Allotropes of carbon, such as hard carbon and crystalline carbon (e.g., graphene, graphite, and nanocarbons, such as carbon nanotubes), are useful for a number of industrial applications, including electrochemical energy conversion and storage (e.g., lithium-ion and sodium-ion batteries), catalysis, and decarbonization. To synthesize carbon allotropes, conventional technologies rely on chemical vapor deposition (CVD) using carbon-containing gas phases. However, such CVD techniques are limited by a relatively slow crystal growth rate (e.g., on the order of hours, or even days). Moreover, conventional technologies (e.g., furnace heating) for producing graphitic carbon often rely on fossil fuels, for example, to provide the initial feedstock and/or for the generation of heat to convert the feedstock. Not only does the reliance on fossil fuels result in substantial energy consumption, but it also contributes to greenhouse gas emissions. Embodiments of the disclosed subject matter may address one or more of the above-noted problems and disadvantages, among other things.

### SUMMARY

Embodiments of the disclosed subject matter provide systems and methods for conversion of organic feedstock to one or more carbon allotropes using a thermal plasma. In some embodiments, the organic feedstock is exposed to the high temperature of the thermal plasma for a relatively short duration (e.g., ≤60 seconds) to convert the organic feedstock into the carbon allotrope(s). Unlike conventional technologies, embodiments of the disclosed subject matter can offer relatively high throughput (e.g., crystalline products produced in minutes, or even seconds, as compared to hours or days required for CVD or furnace heating) as well as being environmentally-friendly (e.g., without requiring the use of fossil fuels) and cost-effective.

In one or more embodiments, a method can comprise generating a thermal plasma between a pair of electrodes. The thermal plasma can have a first temperature of at least 4000 K. The method can further comprise subjecting an organic feedstock to the first temperature of the thermal plasma for a first time period. The first time period can be less than or equal to 60 seconds. The subjecting to the first temperature can convert the organic feedstock to one or more carbon allotropes, such as hard carbon or crystalline carbon.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a flow diagram of an exemplary method for converting organic feedstock to one or more carbon allotropes, according to one or more embodiments of the disclosed subject matter.

FIG. 2A illustrates aspects of a system for converting organic feedstock to one or more carbon allotropes, according to one or more embodiments of the disclosed subject matter.

FIG. 2B is a simplified schematic diagram of a system having an electrode with projecting portions for generating a thermal plasma, according to one or more embodiments of the disclosed subject matter.

FIG. 2C depicts a generalized example of a computing environment in which the disclosed technologies may be implemented.

FIG. 3 is a simplified schematic diagram illustrating aspects of batch conversion of organic feedstock using a thermal plasma, according to one or more embodiments of the disclosed subject matter.

FIG. 4A is a simplified schematic diagram illustrating aspects of gravity-feed configuration for continuous conversion of organic feedstock using a thermal plasma, according to one or more embodiments of the disclosed subject matter.

FIG. 4B shows an exemplary thermal plasma setup for conversion of organic feedstock that employs a gravity feed, according to one or more embodiments of the disclosed subject matter.

FIGS. 4C-4D are simplified schematic diagrams illustrating aspects of alternative gravity-feed configurations for continuous conversion of organic feedstock using a thermal plasma, according to one or more embodiments of the disclosed subject matter.

FIG. 5A is a simplified schematic diagram illustrating aspects of a conveyor-based configuration for continuous conversion of organic feedstock using a thermal plasma, according to one or more embodiments of the disclosed subject matter.

FIG. 5B shows an exemplary thermal plasma setup for conversion of organic feedstock that employs a conveyor belt, according to one or more embodiments of the disclosed subject matter.

FIG. 6A is a transmission electron microscopy (TEM) image of the product formed by plasma processing of flour, with the inset showing the diffraction pattern from the imaged area.

FIG. 6B is a graph of Raman spectroscopy results of the product formed by plasma processing of flour, with the inset showing an optical image of the plasma-processed flour.

FIG. 6C shows the results of X-ray diffraction (XRD) analysis of the product formed by plasma processing of flour.

FIG. 7A is a graph of Raman spectroscopy results of the product formed by plasma processing of polyethylene.

FIG. 7B is a graph of Raman spectroscopy results of the product formed by plasma processing of polyethylene with an iron oxide catalyst, with the inset showing an optical image of the product.

FIG. 8A shows scanning electron microscopy (SEM) images of the product formed by plasma processing (˜4500 K for 30 seconds) of wood.

FIG. 8B shows TEM images of the product formed by plasma processing (˜4500 K for 30 seconds) of wood.

FIG. 8C shows SEM images of the product formed by plasma processing (˜4500 K for 30 seconds) of lignin.

FIG. 8D compares XRD analysis results for the product formed by plasma processing of wood and natural graphite.

FIG. 8E compares Raman spectroscopy results for the product formed by plasma processing of wood and natural graphite.

FIG. 8F shows charge/discharge curves of a lithium-ion battery having an anode formed of wood-derived carbon (assembled using the carbon anode, 60 μL electrolyte, Celgrad 2325 separator, and fresh Li foil in an argon-filled glovebox with H₂O and O₂ levels ≤1 ppm).

FIG. 9A is a simplified schematic diagram of an experiment forming carbon nanotubes from carbon black using a thermal plasma.

FIG. 9B shows SEM and TEM images of the initial carbon black and subsequently formed carbon nanotubes resulting from thermal plasma processing of the carbon black.

### DETAILED DESCRIPTION

### General Considerations

For purposes of this description, certain aspects, advantages, and novel features of the disclosed subject matter are described herein. The disclosed methods and systems should not be construed as being limiting in any way. Instead, the present disclosure is directed toward all novel and nonobvious features and aspects disclosed herein, alone and in various combinations and sub-combinations with one another. The methods and systems are not limited to any specific aspect or feature or combination thereof, nor do the disclosed aspects require that any one or more specific advantages be present, or problems be solved. The technologies from any aspect or example can be combined with the technologies described in any one or more of the other aspects or examples. In view of the many possible aspects to which the principles of the disclosed technology may be applied, it should be recognized that the illustrated aspects of the disclosure are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing aspects from discussed prior art, the numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Thermal Plasma: A three-dimensional volume of electrons, ions, and/or excited molecules created and/or maintained by application of an electric field between electrodes. In some embodiments, the plasma can be generated via application of a direct current (DC) voltage, an alternating current (AC) voltage (e.g., radio frequency (RF), for example, in a range of 3 kHz to 300 GHz), or other waveform (e.g., pulsed voltage waveform) between the electrodes. In some embodiments, the temperature of the generated plasma is at least 1,000 K (e.g., in a range of 1,000-10,000 K, inclusive, such as 4,000-8,000 K, inclusive). In some embodiments, the configuration of the electrodes for generation of the thermal plasma and/or operation of the thermal plasma may be similar to that described in International Publication No. WO-2024/076574, published Apr. 11, 2024 and entitled “Volumetric Plasmas, and Systems and Methods for Generation and Use Thereof,” which is incorporated by reference herein in its entirety.

Cloth or Felt: A structure formed of a plurality of fibers, for example, woven together (e.g., to form a cloth) or otherwise coupled together (e.g., matting, condensing, and/or pressing fibers together to form a felt). In some embodiments, the cloth or felt can be formed of carbon or metal fibers (e.g., a refractory metal or refractory metal alloy). In some embodiments, a carbon cloth or felt can be formed by carbonizing (e.g., at a temperature of at least 1000 K) polyacrylonitrile (PAN) or rayon fibers.

Inert Gas: One or more gases that do not undergo a chemical reaction when subjected to the temperature of a generated plasma, the feedstock, and/or the material of the electrodes. In some embodiments, the inert gas is selected from the group consisting of nitrogen, argon, helium, neon, krypton, xenon, radon, and oganesson.

Refractory material: A material (e.g., element or compound) having a melting temperature (e.g., at atmospheric pressure) of at least 1000 K, for example, at least 1850 K (˜1580° C.). In some embodiments, a refractory material can be as defined in ASTM C71-01, “Standard Terminology Relating to Refractories,” August 2017, which is incorporated herein by reference. In some embodiments, the refractory material can be carbon (e.g., graphite, carbon cloth, carbon felt, carbon nanotubes), refractory metals, refractory metal alloys, refractory ceramics, or any combination thereof.

Refractory metal or refractory metal alloy: A metal or metal alloy having a melting temperature (e.g., at atmospheric pressure) of at least 1000 K, for example, at least 2100 K (˜1850° C.). In some embodiments, the refractory metal can be niobium, molybdenum, tantalum, tungsten, rhenium, alloys thereof, or any combination thereof.

Organic Feedstock: A carbon-containing source material for conversion into one or more carbon allotropes (e.g., hard carbon or crystalline carbon, such as graphene, graphite, or carbon nanotubes). In some embodiments, the organic feedstock comprises a biomass, agricultural waste, carbon black, and/or organic polymer (e.g., plastic, resin, natural polymer, synthetic polymer, etc.). Exemplary plastics for the organic feedstock can include, but are not limited to polyethylene (PE), polypropylene (PP), polystyrene (PS), polyvinyl chloride (PVC), polyethylene terephthalate (PET), polymethyl methacrylate (PMMA), polybutylene terephthalate (PBT), nylon (PA—Polyamide), acetal (POM—Polyoxymethylene), polycarbonate (PC), polyethylene naphthalate (PEN), polyether ether ketone (PEEK), polyphenylene sulfide (PPS), polyphenylene oxide (PPO), polyimide (PI), polytetrafluoroethylene (PTFE), polyetherimide (PEI), polyaryletherketone (PAEK), polysulfonc (PSU), polyether sulfonc (PES), polyamide-imide (PAI), polybenzimidazole (PBI), thermoplastic polyurethane (TPU), thermoplastic olefin (TPO), styrene-butadiene-styrene (SBS), styrene-ethylene-butylene-styrene (SEBS), thermoplastic vulcanizate (TPV), polylactic acid (PLA), polyhydroxyalkanoates (PHA), polybutylene adipate terephthalate (PBAT), polybutylene succinate (PBS), and starch-based plastics.

Biomass: Organic matter derived from living (or previously living) organisms and/or by-products from such living organisms. In some embodiments, the biomass comprises a portion (e.g., a cut portion, via mechanical means or otherwise) of any photosynthetic eukaryote of the kingdom Plantae in its native state as grown, such as but not limited to wood (e.g., hardwood or softwood), bamboo, reed, hemp, palm, cotton, and grass. Alternatively or additionally, in some embodiments, the biomass can comprise bagasse (e.g., formed from processed remains of sugarcane or sorghum stalks), straw (e.g., formed from processed remains of cereal plants, such as rice, wheat, millet, or maize), or cork (e.g., formed from the bark of the cork oak tree). Alternatively or additionally, in some embodiments, the biomass can comprise a recycled plant or plant-based material (e.g., paper, newspaper, cardboard, textile, etc.) or a waste product, such as food waste, animal manure, wood waste (e.g., wood chips, wood shavings, sawdust, Kraft lignin, etc.), or agricultural waste (e.g., hemp, flax, cereal straws, cereal husks, corn stover, etc.). Alternatively or additionally, in some embodiments the biomass can comprise an isolated or processed component of a plant, such as but not limited to cellulose, lignin, hemicellulose, sugar, rubber, flour, and sugar.

### Introduction

Disclosed herein are systems and methods for conversion of organic feedstock (e.g., in the form of solid particles) using a thermal plasma. In some embodiments, the thermal plasma operates under atmospheric pressure (e.g., an atmospheric thermal plasma) and is capable of exposing the organic feedstock to high temperatures (e.g., at least 4000 K) in a controlled manner (e.g., with stable plasma formation and substantially uniform temperature across the plasma volume). In some embodiments, the organic feedstock is exposed to the high temperature of the thermal plasma for a relatively short duration (e.g., ≤60 seconds, such as in a range of 0.5-30 seconds, inclusive), which exposure is able to convert the organic feedstock into the carbon allotrope(s). Unlike conventional technologies, embodiments of the disclosed subject matter can offer relatively high throughput (e.g., crystalline products produced in minutes, or even seconds, as compared to hours or days required for CVD) as well as being environmentally-friendly (e.g., without requiring the use of fossil fuels) and cost-effective.

In some embodiments, selection of the type of organic feedstock (e.g., carbon black, biomass particles, polymer, etc.) and tuning of the plasma exposure conditions (e.g., time, temperature) can allow for selective synthesis of a particular carbon allotrope (e.g., hard carbon, graphite/graphene, or carbon nanotubes). For example, for the same organic feedstock, lower plasma temperatures (e.g., ˜4000 K) and shorter plasma exposure times (e.g., ˜1 second) can yield hard carbon as the product, while higher plasma temperature (e.g., >6000 K) and longer plasma exposure times (e.g., ˜30 seconds) can yield carbon nanotubes as the product. In some embodiments, the products resulting from the conversion of the organic feedstock by the thermal plasma exposure can be high-quality carbon allotropes, for example, with most (e.g., at least 90% on a weight basis) of the products being a desired carbon allotrope, the products consisting essentially of carbon, and/or with the products exhibiting no or few defects in their crystal structures.

### Organic Feedstock Conversion Methods

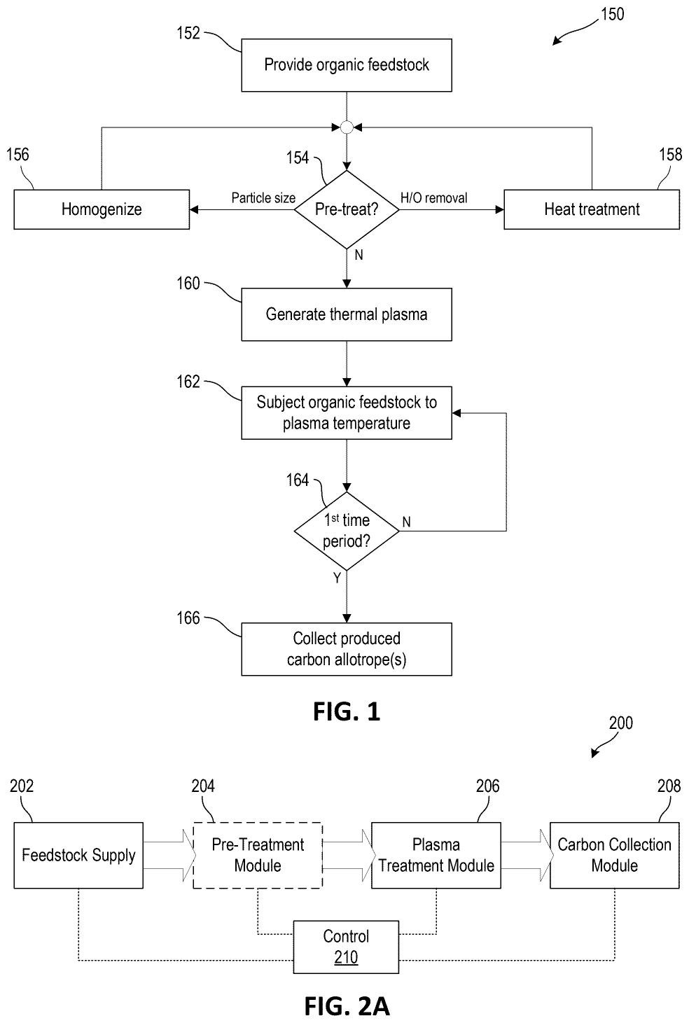

FIG. 1 illustrates aspects of a method 150 for conversion of organic feedstock to carbon allotrope(s) via exposure to a thermal plasma. The method 150 can initiate at process block 152, where an organic feedstock can be provided. For example, the organic feedstock can be in the form of solid particles, such as a biomass, an organic polymer, and/or carbon black. In some embodiments, the organic feedstock can be selected based on a desired carbon allotrope product (e.g., selecting carbon black for conversion to carbon nanotubes). In some embodiments, the provision of process block 152 can include combining, mixing, or otherwise providing the organic feedstock with a catalyst, for example, an iron-based catalyst (e.g., iron oxide), which may help reduce defects in the subsequently produced carbon allotrope. In some embodiments, the provision of process block 152 can include disposing the organic feedstock on a supporting surface (e.g., a portion of an electrode used to form the thermal plasma), flowing the organic feedstock into a gap between electrodes used to form the thermal plasma (e.g., using gravity and/or a carrier gas, such as an inert gas), or otherwise providing the organic feedstock in a region in which the thermal plasma is or will be formed. Alternatively, in some embodiments, the organic feedstock can be arranged with respect to the thermal plasma and/or the electrodes used to form the thermal plasma after a pre-treatment has been performed (e.g., one or both of process blocks 156-158).

At decision block 154 of method 150, it can be determined if a pre-treatment of the organic feedstock is desired. In some embodiments, for example, if the organic feedstock includes particles of different sizes, the organic feedstock can optionally be subjected to pre-treatment in process block 156 to homogenize the particle sizes (e.g., with diameters or maximum cross-sectional dimensions that deviate by no more than 10% from an average value) prior to thermal plasma exposure. For example, the homogenizing pre-treatments of process block 156 can include, but are not limited to, grinding, milling, crushing, sieving, ultrasonic processing, and/or pressure-induced homogenization. Alternatively or additionally, in some embodiments, the organic feedstock can optionally be subjected to pre-heating in process block 158, for example, to at least partially remove hydrogen and/or oxygen compounds from the organic feedstock. In some embodiments, the removal of such compounds from the organic feedstock by the pre-heating can reduce the duration of thermal plasma exposure needed to produce a desired carbon allotrope (e.g., by a factor of at least 10, such as from an initial time range of ˜5-30 seconds to a reduced time range of ˜0.5-1 seconds). For example, the pre-heating treatment of process block 158 can include exposing the organic feedstock to a temperature less than or equal to 500° C. (e.g., in a range of 200-400° C., inclusive) for at least 5 minutes (e.g., 10-120 minutes, inclusive).

After the pre-treatment of process block 156 and/or process block 158, or if no pre-treatment was desired at decision block 154, the method 150 can proceed to process block 160, where the thermal plasma can be generated. In some embodiments, an electric voltage is applied between a pair of opposing electrodes so as to form a thermal plasma in the gap between the facing surfaces of the electrodes. Once the thermal plasma is formed, electric current can flow between the electrodes via the plasma in the gap. In some embodiments, aspects of the thermal plasma can be similar to the systems and/or the methods disclosed in International Publication No. WO-2024/076574, incorporated by reference above. In some embodiments, the thermal plasma may be operated substantially continuously, such that the generation of process block 160 (or at least initiation of the thermal plasma) occurs prior to or contemporaneous with any of blocks 152-158.

For example, in some embodiments, the thermal plasma can be generated at a low breakdown voltage (e.g., ≤100 V, such as 10-80 V, inclusive) and can reach ultrahigh temperatures (e.g., up to 10000 K, such as 3000-8000 K, inclusive) at low current (e.g., ≤50 A, such as 15-45 A, inclusive) and/or current density (e.g., 3-9 A/cm², inclusive). In some embodiments, the characteristics of the thermal plasma (e.g., temperature, distribution, size, and/or location of high temperature zones, etc.) can be adjusted by controlling the gap (e.g., changing size of the gap, with smaller gaps corresponding to higher temperatures) and flow (e.g., particle and/or gas flows) between the electrodes, selecting or altering the gas pressure between the electrodes (e.g., with higher pressures corresponding to higher temperatures), varying applied electric power (e.g., with higher powers corresponding to higher temperatures), applying an external magnetic field, etc. In some embodiments, the thermal plasma can exhibit high temperatures (e.g., ≥1000 K, for example, 1000-10000 K) over relatively large areas (e.g., ≥1 cm²). In some embodiments, the plasma heating configuration is performed in an atmosphere of inert gas (e.g., noble gas, such as argon) between the electrodes. Alternatively or additionally, in some embodiments, the plasma heating configuration is performed in an atmosphere comprising nitrogen, in addition to or in place of the inert gas, for example, to allow for higher temperatures of the thermal plasma.

At process block 162 of the method 150, the organic feedstock can be exposed to the generated thermal plasma, such that the organic feedstock is subjected to the high temperature of the plasma. In some embodiments, the thermal plasma exhibits a temperature in excess of 1000 K, for example, at least 4000 K (e.g., in a range of 4000-8000 K, inclusive). In some embodiments, the exposure of the organic feedstock to the plasma temperature may continue for a first time period, for example, until the organic feedstock has been converted to a desired carbon allotrope. For example, the first time period may be less than or equal to 60 seconds. If the first time period has not yet been reached, the method 150 can repeat process block 162 via decision block 164. Otherwise, the plasma exposure of process block 162, and the corresponding subjecting to the high temperature of the plasma, may terminate at the end of the first time period. In some embodiments, the plasma exposure is terminated at the end of the first time period by terminating the plasma itself (e.g., by turning off the electric current and/or voltage applied to the electrodes, or at least reducing the electric voltage to a level that no longer supports plasma formation). Alternatively or additionally, the plasma exposure is terminated at the end of the first time period by moving the carbon allotrope product out of the plasma or by moving the plasma away from the carbon allotrope product (e.g., by moving one or both of the electrodes).

In some embodiments, by tuning the synthesis conditions (e.g., organic feedstock material, plasma temperature, duration of first time period), aspects of the produced carbon allotrope can be controlled, such as, but not limited to selection of particular allotropes (e.g., between hard carbon, graphite/graphene, and carbon nanotubes), degree of graphitization, surface functionality, and pore size distribution. For example, subjecting organic feedstock to a relatively low plasma temperature and/or for a relatively short duration (e.g., ˜4000 K for 1 second) can lead to the formation of hard carbon with a disordered structure characterized by a random arrangement of carbon atoms. By increasing the plasma temperature and/or the exposure duration, graphite can be formed, which has a highly crystalline structure and exhibits well-aligned carbon atoms. For a higher plasma temperature, shorter heating durations favor the formation of planar graphite structures, while longer heating durations provide the energy needed for carbon vaporization, nucleation, and subsequent carbon nanotube (CNT) growth. For example, heating a feedstock of lignin at ˜4500 K for 30 seconds may result in the exclusive formation of graphite (e.g., with no evidence of CNTs or amorphous carbon structures). In contrast, by heating a feedstock of carbon black at ˜6600 K for 30 seconds, CNTs may be preferentially formed.

After the first time period, the method 150 may proceed from decision block 164 to process block 166, where the carbon allotrope(s) produced from organic feedstock can be collected for use and/or used in a subsequent application. In some embodiments, the collection of process block 166 can include removing the products from the plasma and/or from a gap between the plasma-generating electrodes. Alternatively or additionally, the collection of process block 166 can include removing the products from one of the electrodes, for example, when the products are formed on the electrode (e.g., anode). In such embodiments, the removal can include scraping, slicing, cutting, separating, or otherwise removing the carbon allotrope products from a surface of the electrode. Alternatively or additionally, in some embodiments, the carbon allotrope products can be collected after they exit the plasma and/or gap between the plasma-generating electrodes. In some embodiments, the produced carbon allotropes can be used in a variety of applications, such as but not limited to components in electrochemical energy storage devices (e.g., anode in a lithium ion battery), in composite materials, and/or material coatings.

Although some of blocks 152-166 of method 150 have been described as being performed once, in some embodiments, multiple repetitions of a particular process block may be employed before proceeding to the next decision block or process block. In addition, although blocks 152-166 of method 150 have been separately illustrated and described, in some embodiments, process blocks may be combined and performed together (simultaneously or sequentially). Moreover, although FIG. 1 illustrates a particular order for blocks 152-166, embodiments of the disclosed subject matter are not limited thereto. Indeed, in certain embodiments, the blocks may occur in a different order than illustrated or simultaneously with other blocks. In some embodiments, method 150 may comprise only some of blocks 152-166 of FIG. 1.

### Organic Feedstock Conversion Systems

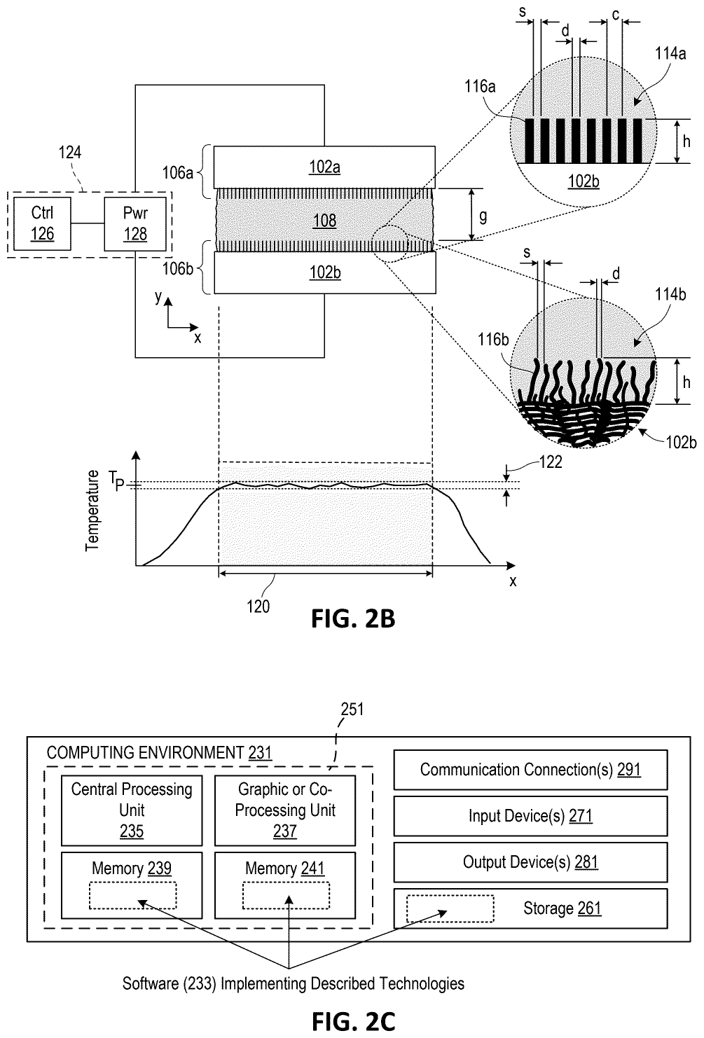

FIG. 2A illustrates aspects of an organic feedstock conversion system 200 according to one or more embodiments of the disclosed subject matter. In the illustrated example, system 200 includes a feedstock supply module 202, an optional pre-treatment module 204 (which can be a single module or multiple separate modules), a plasma treatment module 206, and a carbon allotrope collection module 208. A control system 210 can be operatively coupled to the individual modules 202-208 to control operation thereof. Although illustrated separately, one or more of the modules 202-208, or functions thereof, can be combined together in a single system component or module, according to one or more contemplated embodiments.

In some embodiments, the feedstock supply module 202 can provide an organic feedstock for conversion, for example, by selecting and/or transporting solid particles of biomass, organic polymer, and/or carbon black for processing. The feedstock supply module 202 can include any component for selecting and/or transporting such particles, such as but not limited to, particle hoppers, nozzles, conveyor belts, robotic assemblies, etc.

In some embodiments, the optional pre-treatment module 204 can perform one or more pre-treatments on the provided feedstock, for example, to homogenize particle size of the feedstock and/or to pre-heat for removal of hydrogen and/or oxygen compounds. Other pre-treatments are also possible according to one or more contemplated embodiments, for example, to remove inorganic components or other undesirable materials (e.g., when using a waste stream as the feedstock).

The plasma treatment module 206 can expose the organic feedstock to a high temperature from a thermal plasma for a short period of time, which high temperature exposure can be effective to convert the organic feedstock to one or more carbon allotropes. As discussed in the incorporated International Publication No. WO-2024/076574 and elsewhere herein, the thermal plasma can be generated in a gap between a pair of electrodes, and the high temperature exposure can occur with the organic feedstock disposed within or passing through this gap.

The collection module 208 can collect the resulting carbon allotrope products from the plasma treatment module 206. In some embodiments, the collection module 208 can include a vessel (e.g., crucible) for catching the carbon particles from the plasma treatment module 206 (e.g., conveyed from an exit end of the gap between electrodes). Alternatively or additionally, in some embodiments, the collection module 208 can include means for removing the carbon particles from the plasma treatment module 206, or a component thereof. For example, a moving blade can be used to separate the formed carbon particles from an underlying support structure or an electrode of the plasma treatment module 206. Alternatively or additionally, in some embodiments, the collection module 208 can include any component for selecting and/or transporting such carbon particles, such as but not limited to, particle hoppers, nozzles, conveyor belts, robotic assemblies, etc.

FIG. 2B shows an exemplary plasma treatment system (e.g., for use as plasma treatment module 206). In FIG. 2B, the plasma treatment system has a first electrode 106a, a second electrode 106b, an electrical power supply 128, and a controller 126. In the illustrated example, the first electrode 106a is separated from a second electrode 106b by a gap 108 of thickness, g. In the illustrated example, each electrode has a plurality 114 of projecting portions 116 that extend (e.g., along the y-direction) toward the other electrode; however, in some embodiments, only one of the electrodes may be provided with projecting portions. In some embodiments, the thickness, g, of the gap 108 can be less than 10 cm, for example, in a range of 1 mm to 5 cm. A voltage (DC, AC, or other waveform, such as a pulsed voltage waveform) can be applied across the electrodes 106a, 106b by electrical power supply 128 to form the thermal plasma within the gap 108. In some embodiments, during the thermal plasma, a peak voltage applied between the electrodes 106a, 106b can be less than or equal to 100 V (e.g., ≤50 V), and/or a peak current between the electrodes 106a, 106b can be less than or equal to 100 A (e.g., ≤50V).

In some embodiments, the thermal plasma can be generated at any pressure, with or without application of a magnetic field, for example, in a range from 1 Torr to 10 atm. In some embodiments, the thermal plasma can exhibit a substantially uniform temperature across a lateral extent 120 (e.g., in the x-z plane) of the plasma. In some embodiments, the lateral extent 120 of the plasma can be at least 1 mm, for example, in a range of 1 mm to 100 cm. In some embodiments, the temperature at different points in the thermal plasma along its lateral extent 120 can be within a narrow band 122 around a plasma temperature, T_{P}, for example, less than or equal to 10% of the plasma temperature (e.g., band=+50 K for T_{P}=1000 K). In some embodiments, the plasma temperature, T_{P}, can be at last 1000 K, for example, in a range of 1000-10000 K (e.g., 4000-8000 K). In some embodiments, the plasma temperature, T_{P}, can be an average temperature across the lateral extent 120 of the thermal plasma, or a temperature at a center (e.g., in the x-z plane) of the lateral extent 120 of the thermal plasma.

In some embodiments, the plasma temperature, T_{P}, can be changed by selecting or altering the power input from power supply 128 (e.g., with higher powers corresponding to higher temperatures), selecting or altering the distance, g, of the gap 108 (e.g., with smaller gaps corresponding to higher temperatures), and/or selecting or altering the gas pressure between the two electrodes 106a, 106b (e.g., with higher pressures corresponding to higher temperatures). In some embodiments, the thermal plasma can be temporally stable, for example, such that the profile of temperature across lateral extent 120 and/or plasma temperature, T_{P}, stays about the same for a substantially constant power input (e.g., power of a DC signal, power and frequency for an AC signal, power and frequency for a pulsed voltage waveform, etc.) for any amount of time, for example, at least 1 minute (e.g., ≥10 minutes).

Controller 126 can control operation of the electrical power supply 128, for example, timing, application, and/or magnitude of the voltage, current, or electrical power applied across the electrodes 106a, 106b, which may in turn control characteristics of the thermal plasma (e.g., on/off, temperature, etc.). In the illustrated example, controller 126 is operatively coupled to the electrical power supply 128. Alternatively or additionally, controller 126 and the electrical power supply 128 may be considered part of a unitary system, for example, different modules of a control system 124. In some embodiments, controller 126 can control other aspects of the system, for example, size of gap 108, pressure between electrodes 106a, 106b, and/or feedstock flow characteristics (e.g., feedstock flow rate, carrier gas flow rate, etc.).

In the illustrated example of FIG. 2B, the projecting portions extend from a base layer 102a, 102b of the respective electrode 106a, 106b. In some embodiments, the projecting portions can be disposed on or formed from a surface of the base layer 102b, for example, pillars 116a of plurality 114a in the top inset of FIG. 2B. Alternatively or additionally, in some embodiments, the projecting portions are exposed or cut surface portions of the base layer 102b, for example, fibers 116b of plurality 114b in the bottom inset of FIG. 2B. In some embodiments, cach projecting portion 116 can have a cross-sectional dimension (e.g., a maximum or minimum cross-sectional dimension in the x-z plane, for example, a diameter), d, less than or equal to 500 μm. In some embodiments, the cross-sectional dimension, d, for the projecting portions 116 can be greater than 1 μm, for example, in a range of 1-100 μm. In some embodiments, the cross-sectional dimension, d, may represent an average of cach of the projecting portions 116, with the cross-sectional dimensions of the projecting portions 116 being within 10% of the average.

In some embodiments, the spacing, s, between adjacent projecting portions 116 (e.g., along the x-direction, along the z-direction, and/or along the x-z plane) can be less than or equal to 1 mm. In some embodiments, the spacing, s, can be about the same or less than the cross-sectional dimension, d, for example, less than or equal to 100 μm (e.g., in a range of 1-50 μm). In some embodiments, the spacing, s, may represent an average spacing across the plurality 114. In some embodiments, the individual spacings between pairs of projecting portions 116 can be within 10% of the average. In some embodiments, the combination of the cross-sectional dimension, d, and spacing, s, can yield a center-to-center spacing, c, less than 1 mm, for example, 1-100 μm. Alternatively or additionally, the plurality 114 can exhibit a density of at least 10⁴ projecting portions per cm², for example, about 10⁵ portions/cm².

In some embodiments, the length, h, of the projecting portions 116 (e.g., along the y-direction from a surface of the base layer) can be greater than its cross-sectional dimension, d. Alternatively or additionally, the length, h, of the projecting portions 116 can be less than the gap size, g. In some embodiments, the length, h, of the projecting portions 116 can be greater than or equal to 100 μm and/or less than or equal to 1 cm, for example, in a range of 200-500 μm. In some embodiments, the length, h, may represent an average length across the plurality 114. In some embodiments, the length of each projecting portion 116 can be within 10% of the average. In some embodiments, cach projecting portion can be substantially straight and extend substantially parallel to a thickness of the gap (e.g., parallel to the y-direction), for example, as shown by pillars 116a in FIG. 2B. Alternatively or additionally, in some embodiments, cach projecting portion can deviate from being substantially straight along at least part of its length, and/or have a part at an angle with respect to a thickness of the gap (e.g., extending in the x-z plane), for example, as shown by fibers 116b in FIG. 2B, in which case the length, h, can be the distance the projecting portion extends along the y-direction.

In some embodiments, the projecting portions can be formed by a three-dimensional printing modality, such as but not limited to laser-based direct energy deposition or laser powder-bed fusion. Alternatively or additionally, in some embodiments, the array of projecting portions can be formed from the underlying base layer, for example, by cutting, abrading, and/or roughening a surface of a cloth or felt formed of refractory material fibers (e.g., carbon or metal fibers). In some embodiments, the underlying base layer can comprise woven fibers, and the projecting portions can be arranged in bundles based on the weave pattern.

In some embodiments, a system for generating the thermal plasma can include means for initiating the plasma, for example, by providing a smaller distance than the gap between electrodes such that gas discharge occurs at a lower voltage than would otherwise be possible. In some embodiments, the initiating means can be temporary, for example, removed or altered once the plasma is initiated. In some embodiments, the initiating means can be reusable or reproducible, for example, to initiate the plasma between the electrodes more than once. Alternatively, in some embodiments, the initiating means may be consumable, for example, degraded or decomposed by the high temperatures of the generated thermal plasma.

In some embodiments, the thermal plasma can be generated by applying voltage between the electrodes separated by a first gap, a surface of at least one of the electrodes that faces the first gap can have a plurality of first projecting portions, and a surface of at least one of the electrodes that faces the first gap can have a plurality of second projecting portions (e.g., pillars, fibers, tips, or other surface protrusions). In some embodiments, the first and second projecting portions can be on the same surface, with the second projecting portions being longer than the first projecting portions so as to extend into the first gap between the electrodes. In some embodiments, the second projecting portions form a narrower second gap with the other electrode (e.g., a surface of the other electrode facing the gap, a first projecting portion extending from the surface of the other electrode, or a second projecting portion extending from the surface of the other electrode). In some embodiments, the narrower second gap can be at least an order of magnitude smaller than the first gap and/or have a size that is within an order of magnitude of a cross-sectional dimension of the second projecting portion. In some embodiments, gas discharge can occur across the second gap at a voltage (or power) much lower than that needed to generate gas discharge across the first gap, for example, by at least an order of magnitude. In some embodiments, one or both of the electrodes 106a, 106b may be movable with respect to the other, for example, to compensate for gradual consumption of the electrodes by the thermal plasma by maintaining a predetermined or initial size of the gap and/or to temporarily reduce a size of the gap to decrease the voltage required to initiate the thermal plasma.

### Computer Implementation Examples

FIG. 2C depicts a generalized example of a suitable computing environment 231 in which the described innovations may be implemented, such as but not limited to method 150, control system 124, power supply 128, controller 126, and/or control system 21. The computing environment 231 is not intended to suggest any limitation as to scope of use or functionality, as the innovations may be implemented in diverse general-purpose or special-purpose computing systems. For example, the computing environment 231 can be any of a variety of computing devices (e.g., desktop computer, laptop computer, server computer, tablet computer, etc.).

With reference to FIG. 2C, the computing environment 231 includes one or more processing units 235, 237 and memory 239, 241. In FIG. 2C, this basic configuration 251 is included within a dashed line. The processing units 235, 237 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 2C shows a central processing unit 235 as well as a graphics processing unit or co-processing unit 237. The tangible memory 239, 241 may be volatile memory (e.g., registers, cache, RAM), non-volatile memory (e.g., ROM, EEPROM, flash memory, etc.), or some combination of the two, accessible by the processing unit(s). The memory 239, 241 stores software 233 implementing one or more innovations described herein, in the form of computer-executable instructions suitable for execution by the processing unit(s).

A computing system may have additional features. For example, the computing environment 231 includes storage 261, one or more input devices 271, one or more output devices 281, and one or more communication connections 291. An interconnection mechanism (not shown) such as a bus, controller, or network interconnects the components of the computing environment 231. Typically, operating system software (not shown) provides an operating environment for other software executing in the computing environment 231, and coordinates activities of the components of the computing environment 231.

The tangible storage 261 may be removable or non-removable, and includes magnetic disks, magnetic tapes or cassettes, CD-ROMs, DVDs, or any other medium which can be used to store information in a non-transitory way, and which can be accessed within the computing environment 231. The storage 261 can store instructions for the software 233 implementing one or more innovations described herein.

The input device(s) 271 may be a touch input device such as a keyboard, mouse, pen, or trackball, a voice input device, a scanning device, or another device that provides input to the computing environment 231. The output device(s) 281 may be a display, printer, speaker, CD-writer, or another device that provides output from computing environment 231.

The communication connection(s) 291 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Batch Processing Configurations

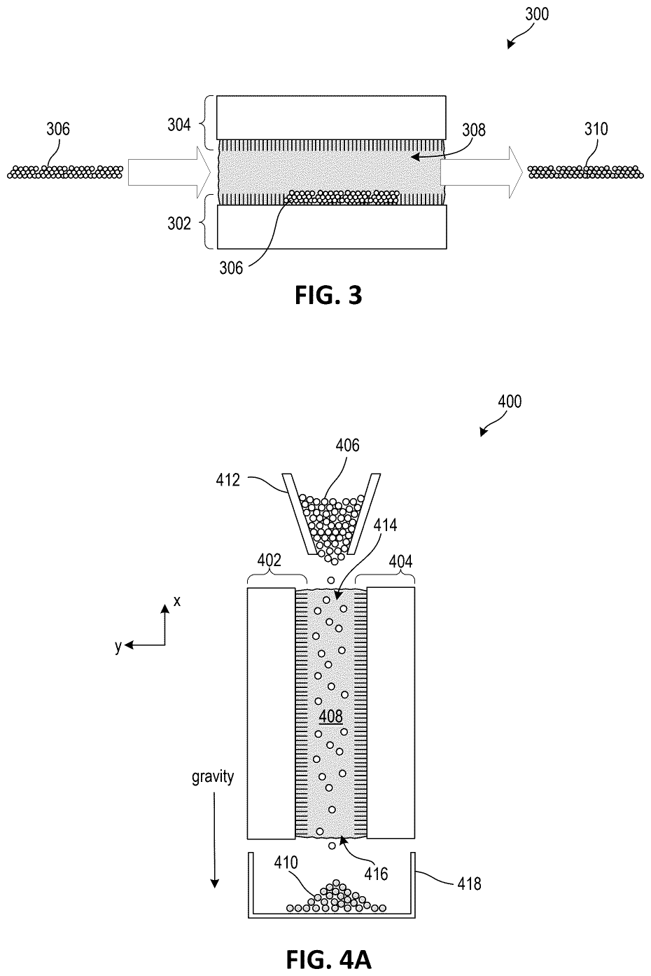

FIG. 3 illustrates an exemplary plasma system configuration 300 for conversion of a batch of organic feedstock particles 306 into carbon allotrope particles 310. The plasma system configuration 300 includes a first electrode 302 and a second electrode 304 spaced apart from each other by a gap 308, and the thermal plasma can be generated within the gap 308 between the electrodes 302, 304. In the illustrated example, the organic feedstock particles 306 are disposed directly on and supported by part of the first electrode 302 (e.g., operating as an anode). However, in some embodiments, the feedstock particles 306 can instead be supported within the gap 308, for example, by a separate support member (not shown), so as to avoid contacting either of the electrodes 302, 304, or to only contact second projecting portions of one or both electrodes 302, 304.

In some embodiments, the organic feedstock particles 306 can be provided within the gap 308 prior to initiation of the thermal plasma, and/or the carbon allotrope particles 310 can be removed from the gap after termination of the thermal plasma. For example, the particles 306 can be substantially stationary on the first electrode 302 during the high temperature exposure, for example, by placing the particles 306 within the gap 308 prior to plasma generation, then initiating and maintaining the thermal plasma to provide a desired duration of heating at the plasma temperature, and then ceasing the thermal plasma and removing the carbon allotrope particles 310 from the first electrode 302. For example, the transition to/from the plasma temperature may be at a rate of at least 10² K/s. Alternatively, in some embodiments, the organic feedstock particles 306 can be introduced into the gap 308 once the thermal plasma has already been initiated and/or stabilized, and/or the carbon allotrope particles 310 can be removed with the thermal plasma continues to operate.

### Continuous Processing Configurations-Stationary Electrodes

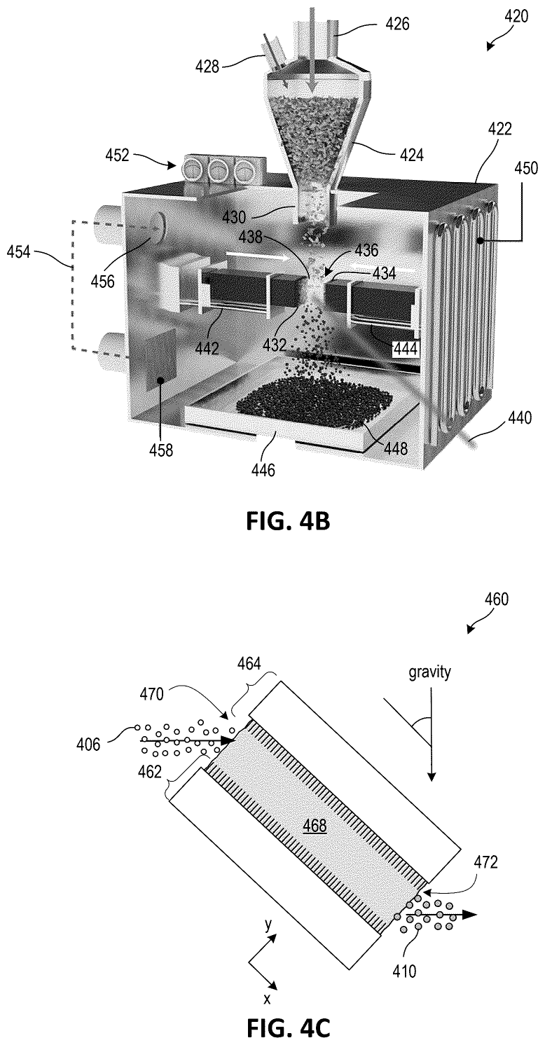

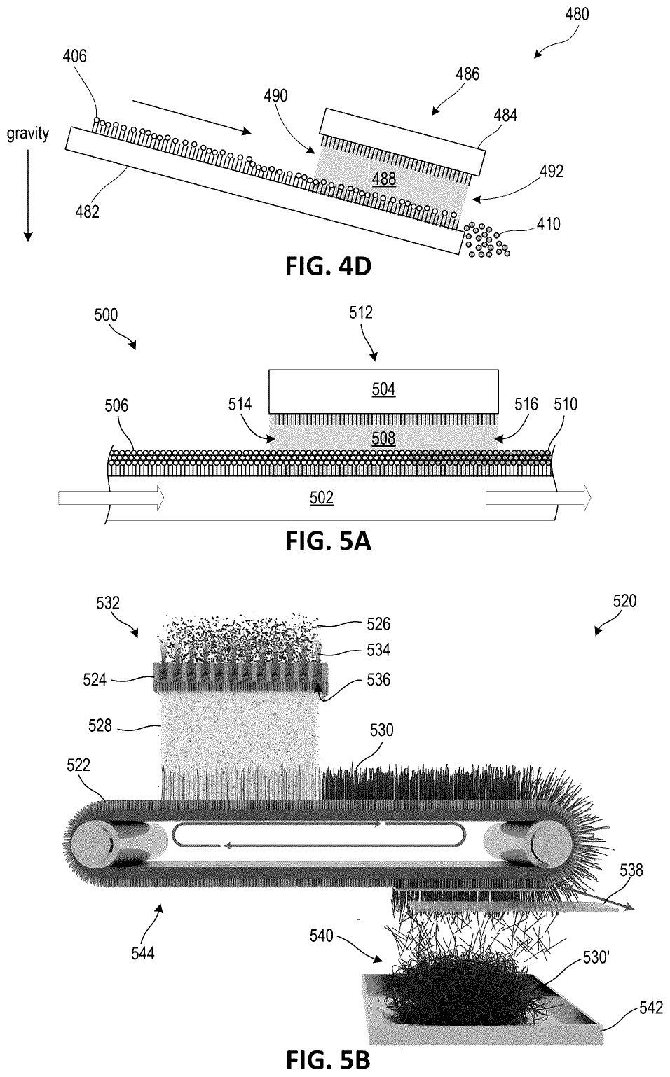

FIG. 4A illustrates an exemplary plasma system configuration 400 for conversion of a continuous supply of organic feedstock particles 406 into carbon allotrope particles 410. The plasma system configuration 400 includes a first electrode 402 and a second electrode 402 spaced apart from each other along a horizonal direction by a gap 408, and the thermal plasma can be generated within the gap 408 between the electrodes 402, 404. In the illustrated example, the gap 408 extends along a direction of gravity, with the top end 414 of the gap 408 receiving an input of feedstock particles 406 from nozzle 412. Because of the orientation of the gap 408, gravity can be used to move the feedstock 406 into and through the thermal plasma within the gap 408 and/or to convey carbon allotrope particles 410 from a bottom end 416 of the gap 408. A duration of exposure of the organic particles 406 to the plasma temperature can be determined by residence time of the particles 406 within the gap 408, for example, based on a vertical length of the gap 408 and/or the generated thermal plasma, and a speed/acceleration of the particles 406 (e.g., induced by gravity). Alternatively or additionally, a carrier gas (e.g., inert gas) can be provided to move the particles 406 from the nozzle 412 into the plasma and/or through the gap 408. A collection vessel or member 418 (e.g., crucible) disposed proximal to the bottom end 416 of the gap 408 can collect the produced carbon allotrope particles 410.

In an exemplary operation, the organic feedstock particles 406 can be fed through the nozzle 412 into the thermal plasma within gap 408, which can be formed under inert gas (e.g., argon) at atmospheric pressure. In some embodiments, due to the high plasma temperature (e.g., 4000-8000 K), C—H and C—O bonds of the organic particles 406 can be broken while the particles travel within the gap 408, thereby generating highly reactive atomic carbon as well as atomic hydrogen (which may help avoid, or at least reduce, the oxidation of the carbon species). In some embodiments, this atomic carbon can assemble to form high-quality crystalline carbon (e.g., graphene) as the product particles 410, for example, while within gap 408, as they exit the gap 408 via bottom end 416, and/or as they cool within collection member 418.

FIG. 4B illustrates an exemplary conversion system 420 employing aspects of the plasma system configuration 400 of FIG. 4A. In the illustrated example of FIG. 4B, the conversion system 420 includes a reaction chamber 422 defining an interior volume in which the thermal plasma 438 is generated and in which carbon allotrope particles 448 are collected. Organic feedstock particles are provided to an inlet port 426 of hopper 424, which directs the particles, via outlet 430, to flow through gap 436 between a first electrode 432 and a second electrode 434 within the interior volume of the reaction chamber 422. As the feedstock particles pass through the gap 436, they are converted to carbon allotrope particles 448 due to the high temperature of the plasma 438. These carbon allotrope particles 448 fall under the action of gravity from the gap 436 and are collected by vessel 446 (e.g., tray).

A carrier gas (e.g., an inert gas, such as argon) can be provided to a second inlet port 428 of hopper 424, for example, to supplement the gravity-induced feed of feedstock particles out of the hopper 424 and into the reaction chamber 422. In some embodiments, the feedstock particles can be fully decomposed to carbon vapor when subjected to the plasma temperature in the gap 436. The provision of the carrier gas can assist the carbon vapor in traveling downward to exit the gap 436, thereby subjecting the carbon vapor to a large temperature gradient that encourages the carbon to under nucleation and growth on the surface of the collection vessel 446, for example, to form CNTs. Alternatively or additionally, a separate inert gas can be provided within the interior of the reaction chamber 422, for example, via illustrated recirculating gas flow 454, which filters inert gas from the reaction chamber 422 via dust filter 458 and reintroduces the filtered inert gas via port 456.

In some embodiments, the system 420 can include one or more means for monitoring and adjusting operation of the feedstock conversion treatment. For example, in the illustrated example of FIG. 4B, the first electrode 432 and the second electrode 434 are mounted on respective translation stages 442, 444 within the reaction chamber 422, which translation stages 442, 444 can allow adjustment of the size of the gap 436, for example, to compensate for electrode degradation over time. Alternatively or additionally, the reaction chamber 422 can include one or more sensors, for example, for measuring pressure within the reaction chamber 422, oxygen levels within the reaction chamber 422, and/or humidity within the reaction chamber, the results of which can be communicated via a sensor panel 452. Alternatively or additionally, a laser beam 440 can be used to monitor a temperature of the plasma in a non-contact manner. Other sensing modalities and configurations are also possible according to one or more contemplated embodiments. In some embodiments, the reaction chamber 422 can be provided with a temperature control means, for example, heat exchanger tubing 450, which can be used to cool an exterior of the reaction chamber 422 (e.g., using water cooling).

In the illustrated examples of FIGS. 4A-4B, the gap between electrodes (and the corresponding flow of particles into, through, and out of the gap) is substantially parallel to the direction of gravity. However, in some embodiments, the lateral extension of the gap may be at an angle (e.g., a non-orthogonal angle) with respect to gravity, for example, as shown by the inclined gravity-feed configuration 460 of FIG. 4C. In this illustrated example, organic feedstock particles 406 are provided to top end 470 of gap 468 between first electrode 462 and second electrode 464, and gravity causes the particles 406 to move (e.g., roll and/or slide) down the first electrode 462 (e.g., operating as an anode) and/or product particles to exit the gap 468 via bottom end 472. In some embodiments, similar to the operation of FIG. 4A, a duration of the plasma temperature exposure can be determined by residence time of the particles 406 within the gap 468, for example, based on a length of the gap 468 and/or the gencrated thermal plasma, and a speed/acceleration of the particles 406 (e.g., induced by gravity and influenced by friction and/or other surface characteristics of the inclined first electrode).

In the illustrated examples of FIGS. 4A-4C, the facing surfaces of the first and second electrodes are the same size. However, different sized electrodes are also possible according to one or more contemplated embodiments. In such embodiments, the thermal plasma may be formed within the gap between facing surfaces portions of the first and second electrodes, whereas other surface portions not facing an opposing electrode can be used for a different purpose, such as conveying input feedstock to and/or conveying product particles from the thermal plasma. For example, FIG. 4D shows another plasma system configuration 480 for conversion of organic feedstock 406 into carbon allotrope particles 410. In the illustrated example, the organic feedstock particles 406 can be provided on a static inclined support member 482. Gravity can cause the particles 406 to move (e.g., roll and/or slide) down the support member 482 into the gap 488 (via top end 490) of a plasma reactor stage 486, as well as carbon allotrope particles 410 to exit plasma reactor stage 486 via bottom end 492 of the gap 488. In the illustrated example, the plasma within the gap 488 is generated using a fixed electrode 484 and a facing part of the inclined support member 482. In some embodiments, similar to the operation of FIG. 4C, a duration of the heating can be determined by residence time of the particles 406 within the gap 488, for example, based on a length of the gap and/or the generated plasma, and a speed/acceleration of the particles (e.g., induced by gravity and influenced by friction and/or other surface characteristics of the inclined support member).

### Continuous Processing Configurations-Moving Electrode

In some embodiments, in addition or instead of gravity or a carrier gas flow, a dynamic support member or a moving electrode can be used to move the organic precursor into the thermal plasma and/or to remove the generated carbon products from the thermal plasma. For example, FIG. 5A shows a plasma system configuration 500 for heating organic feedstock particles 506 supported on a conveyor 502 to form carbon allotrope particles 510. In the illustrated example, the plasma in plasma reactor stage 512 is generated using a fixed electrode 504 (e.g., cathode) and a facing part of the moving conveyor 502 (e.g., anode). Translation of the conveyor 502 can be used to move the feedstock 506 into (e.g., via input end 514 of gap 508) and through the thermal plasma within gap 508 and/or to convey carbon allotrope particles 510 from the thermal plasma (e.g., output end 516 of gap 508). In some embodiments, a duration of the exposure of the organic particles 506 to the plasma temperature can be determined by residence time of the particles 506 within the gap 508, for example, based on length of the gap 508 and/or the generated thermal plasma, and a speed of the conveyor 502.

FIG. 5B illustrates an exemplary conversion system 520 employing aspects of the plasma system configuration 500 of FIG. 5A. In the illustrated example of FIG. 5B, the conversion system 520 includes a looped conveyor belt 522 acting as a first electrode (e.g., anode), a static, porous electrode 524 (e.g., cathode), a scraping blade 538, and a collection vessel 542. The facing surfaces between the static electrode 524 and the conveyor belt 522 define a plasma reactor stage 532, in particular, where the thermal plasma 528 can be formed in the gap between facing surfaces. The static electrode 524 can have a plurality of holes or pores 536, through which feedstock particles 526 (e.g., carbon black or other amorphous carbon) can be injected, along with a carrier gas 534 (e.g., inert gas), into the gap between electrodes (and the thermal plasma formed thercin) for conversion of the feedstock into carbon allotrope particles, for example, CNTs 530. The CNTs 530 can be formed on and coupled to the facing surface of the conveyor belt 522 as it exits the thermal plasma 528, and the scraping blade 538 can be used away from the plasma reactor stage 532 to remove the CNTs 530 from the conveyor belt 522, for example, within harvest region 540. The harvested CNTs 530′ removed by blade 538 can be collected in vessel 542 for subsequent use or processing, while the now-cleared surface portion 544 of the conveyor belt 522 can return to the plasma reactor stage 532 for re-use.

### Fabricated Examples and Experimental Results

### Thermal Plasma Processing of Flour

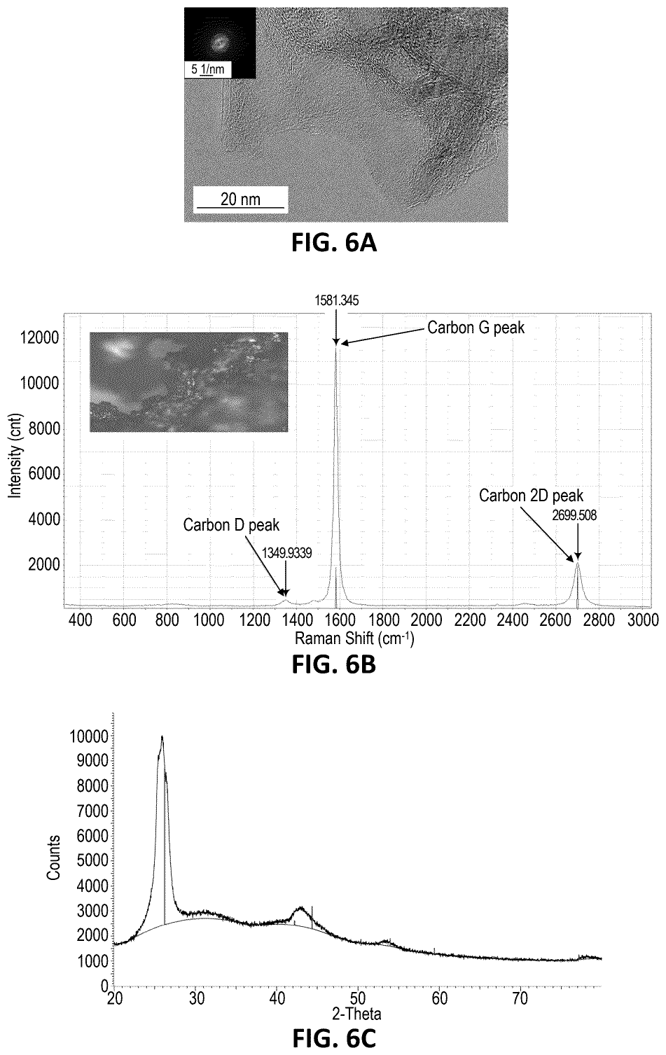

Using an experimental setup similar to that illustrated in FIG. 4A, an organic feedstock of flour was converted to graphene using an atmospheric thermal plasma. The transmission electron microscopy (TEM) images of the plasma-processed flour in FIG. 6A reveal Moire patterns, suggesting formation of a few layers of graphene. Moreover, the inset in FIG. 6A shows clear diffraction patterns for the plasma-processed flour, indicating a highly-crystalline graphitic structure. Successful synthesis of graphene from the flour was further confirmed by Raman spectroscopy (FIG. 6B) and X-ray diffraction (XRD) characterization (FIG. 6C). As shown by the Raman spectroscopy results, the graphene resulting from the thermal plasma conversion of flour exhibits a high G-to-D ratio (˜55), which is indicative of a low defect graphitic structure. Moreover, the broad XRD peaks of the produced graphene are close to those of graphite (red lines), while the symmetric 2D peak for the produced graphene is also a signature of graphene with a few layers (as compared to a non-symmetric 2D peak for graphite).

### Thermal Plasma Processing of Polyethylene

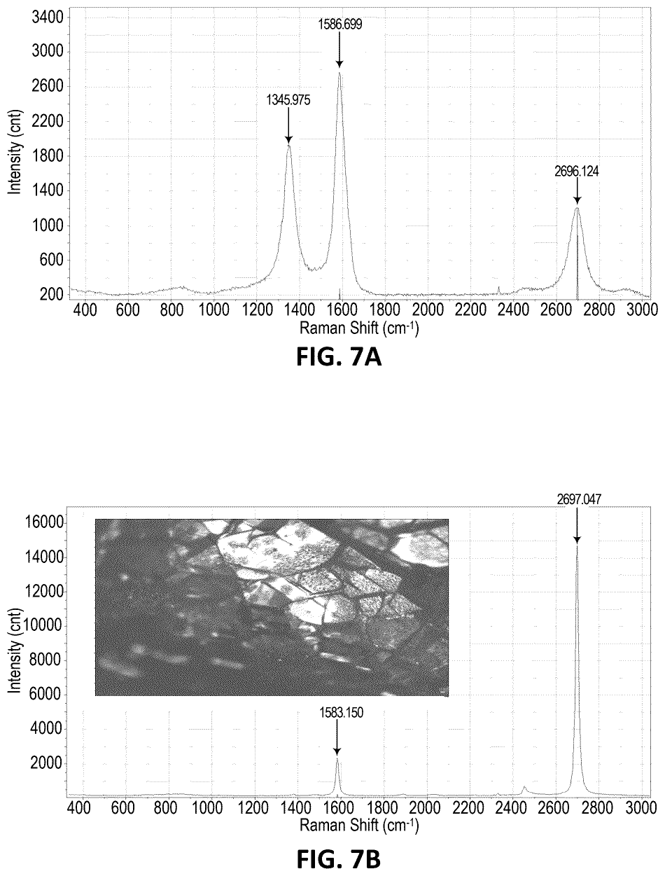

Using an experimental setup similar to that illustrated in FIG. 4A, an organic feedstock of polyethylene was converted to graphene using an atmospheric thermal plasma. FIG. 7A shows a Raman spectrum of the resulting particles produced by plasma-processing the polyethylene. The symmetric 2D peak confirms the synthesis of graphene with a few layers. However, the G-to-D ratio is less than 2:1, which suggests the existence of significant amounts of defective carbon structures. To reduce the defects, an iron-based catalyst was added to the polyethylene prior to plasma processing. In particular, polyethylene and iron oxide were mixed together in a 2:1 mass ratio and then the mixture was subjected to the disclosed thermal plasma processing. FIG. 7B shows a Raman spectrum of the resulting particles produced by plasma-processing the mixture of polyethylene and iron oxide. As shown by the absence of a D peak and ultrahigh 2D-to-G ratio (e.g., as high as 7) in FIG. 7B, a defect-free high-quality graphene was formed. While a defect-free graphene was synthesized using iron oxide as a catalyst, an extra acid-washing and filtering process may be needed to separate the graphene from the iron products.

### Thermal Plasma Processing of Wood

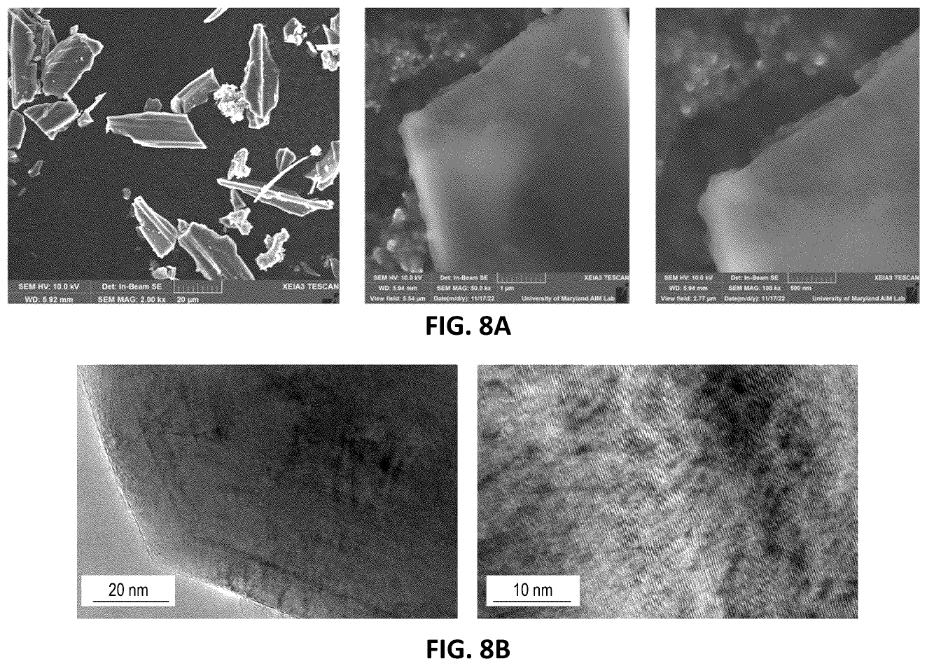

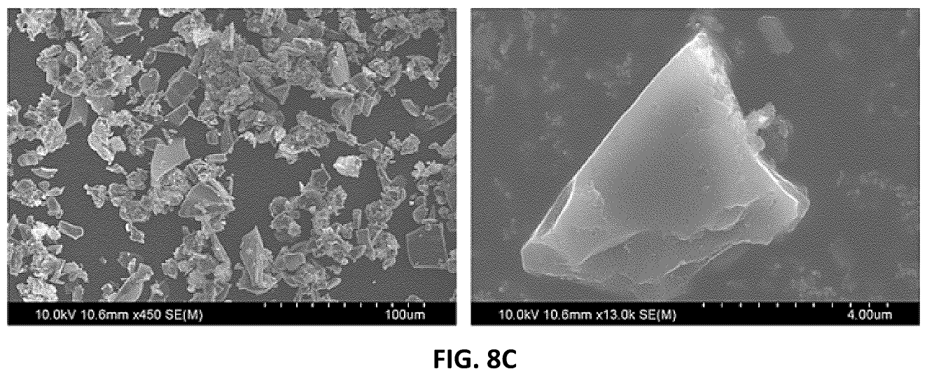

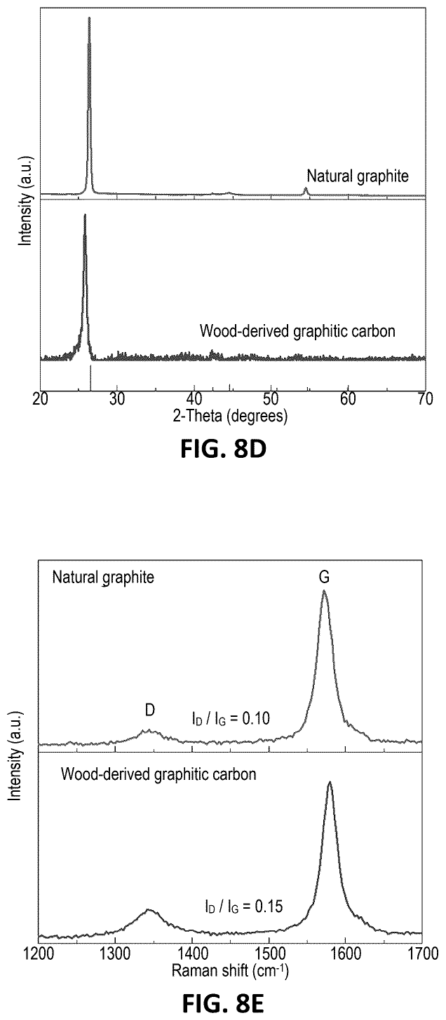

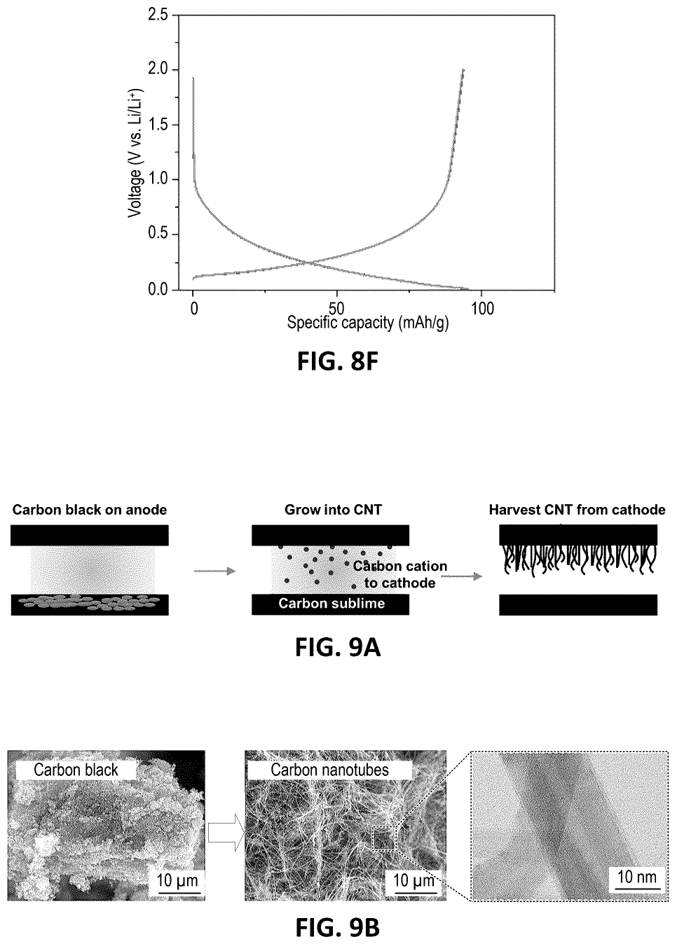

Using an experimental setup similar to that illustrated in FIG. 3, an organic feedstock of wood was converted to graphitic carbon using an atmospheric thermal plasma. In particular, the wood was subjected to a temperature of ˜4500 K for 30 second by the atmospheric thermal plasma. As shown in the images of FIGS. 8A-8B, the resulting carbon products have a high degree of order. Moreover, the XRD and Raman spectra of FIGS. 8D-8E confirm that the wood-derived graphitic carbon possesses a high degree of graphitization, similar to that of natural graphite. As a further demonstration of utility, the wood-derived carbon was then used as the anode in a lithium ion battery, which exhibited a discharge capacity of ˜97 mAh/g at 0.5° C., as shown in FIG. 8F. An organic feedstock of lignin was separately processed in a similar manner, and similarly yielded graphitic carbon, as shown in the images of FIG. 8C.

### Thermal Plasma Processing of Carbon Black

CH₄-derived carbon black powder (50 mg) was spread on the surface of the lower tip-enhanced electrode (anode), as shown in FIG. 9A. A programmable power supply was used to generate the plasma and heat the samples for 30 seconds at a plasma temperature of around 6600 K, as measured by Rayleigh scattering. No catalyst was utilized in the process. The material was then cooled down to room temperature. The CNTs were harvested from the cathode for further characterization, as shown in FIG. 9A. As shown in FIG. 9B, SEM and TEM images of the CNTs confirm the transition of carbon black to multiwalled CNTs (˜5-15 carbon layers) after the thermal plasma treatment. Electron energy loss spectroscopy (EELS) analysis of the CNTs further shows a typical carbon K edge profile. These results demonstrate the potential of the disclosed plasma processing techniques in making value-added products, such as CNTs, from carbon black, which is a widely available and inexpensive byproduct from the petroleum industry.

### Conclusion

Any of the features illustrated or described herein, for example, with respect to FIGS. 1-9B, can be combined with any other feature illustrated or described herein, for example, with respect to FIGS. 1-9B, to provide materials, systems, devices, structures, methods, aspects, or embodiments not otherwise illustrated or specifically described herein. All features described herein are independent of one another and, except where structurally impossible, can be used in combination with any other feature described herein. In view of the many possible aspects to which the principles of the disclosed technology may be applied, it should be recognized that the illustrated features are only examples and should not be taken as limiting the scope of the disclosed technology. Rather, the scope is defined by the following claims. Applicant therefore claims all that comes within the scope and spirit of these claims.

1. A method comprising:
generating a thermal plasma between a pair of electrodes, the thermal plasma having a first temperature of at least 4000 K; and
subjecting an organic feedstock to the first temperature of the thermal plasma for a first time period so as to convert the organic feedstock to one or more carbon allotropes,
wherein the first time period is less than or equal to 60 seconds.

2. The method of claim 1, wherein the organic feedstock comprises particles of biomass, organic polymer, carbon black, or any combination of the foregoing.

3. The method of claim 1, wherein the one or more carbon allotropes comprise crystalline carbon.

4. The method of claim 3, wherein the crystalline carbon comprises graphite or graphene.

5. The method of claim 1, wherein the first temperature is in a range of 4000-8000 K, inclusive.

6. The method of claim 1, wherein:
prior to the subjecting, the organic feedstock is disposed on a first electrode of the pair of electrodes;
after the subjecting, the one or more carbon allotropes are disposed on the first electrode; and
the method further comprises, after the subjecting, harvesting the one or more carbon allotropes from the first electrode.

7. The method of claim 1, wherein:
during the subjecting, the organic feedstock moves with respect to at least one of the pair of electrodes; and
movement of the organic feedstock defines the first time period.

8. The method of claim 7, wherein the movement of the organic feedstock is driven at least in part by gravity, a gas flow, or both.

9. The method of claim 8, wherein the pair of electrodes are separated by a gap having a top end and a bottom end, and the method further comprises:
providing the organic feedstock to the top end of the gap; and
collecting the one or more carbon allotropes at or proximal to a bottom end of the gap.

10. The method of claim 1, wherein:
during the subjecting, a first electrode of the pair of electrodes moves with respect to a second electrode of the pair of electrodes;
after the subjecting, the one or more carbon allotropes are disposed on the first electrode; and
the method further comprises:
prior to the subjecting, providing the organic feedstock within a gap formed between the first and second electrodes; and
after the subjecting, harvesting the one or more carbon allotropes from the first electrode.

11. The method of claim 10, wherein the first electrode comprises a moving belt.

12. The method of claim 10, wherein the harvesting comprises using a blade to scrape the one or more carbon allotropes from a surface of the first electrode.

13. The method of claim 10, wherein the providing comprises flowing the organic feedstock into the gap through one or more openings in the second electrode.

14. The method of claim 1, further comprising, prior to the subjecting, processing the organic feedstock to have a substantially uniform particle size.

15. The method of claim 1, further comprising, prior to the subjecting, exposing the organic feedstock to preheating at a second temperature for a second time period, the second temperature being less than or equal to 500° C., and the second time period is at least 5 minutes.

16. The method of claim 15, wherein the second temperature is in a range of 200-400° C., inclusive, and/or the second time period is in a range of 10-120 minutes, inclusive.

17. The method of claim 15, wherein the first time period is less than or equal to 1 second.

18. The method of claim 1, wherein the thermal plasma is generated at atmospheric pressure in an inert gas environment.

19. The method of claim 1, wherein a catalyst is provided with the feedstock during the subjecting.

20. The method of claim 1, wherein:
a first electrode of the pair of electrodes comprises a first base layer and a plurality of first projecting portions that extend along a first direction from the first base layer toward a second electrode of the pair of electrodes;
the first base layer comprises a first electrically-conductive material, and at least some of the first projecting portions comprise a second electrically-conductive material; and
the first electrically-conductive material, the second electrically-conductive material, or both comprise carbon or graphite.
